(19) United States
(12) Patent Application Publication
(10) Pub. No.: US 2002/0195204 A1
(43) Pub. Date: Dec. 26, 2002

(54) Tape dispenser provided with means to prevent bodily injury of a user thereof

(76) Inventor: Harrison Huang, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/907,700

(22) Filed: Jul. 19, 2001

(30) Foreign Application Priority Data
Jun. 26, 2001 (TW) 90210659

(51) Int. Cl. B32B 35/00

(52) U.S. Cl. 156/577

(57) ABSTRACT

A tape dispenser comprises a hand grip which is provided on the top with a base board fastened therewith. The base board is provided in the rear end of one side thereof with a tape pivoting portion, in the front end with a seat body which is provided in the bottom with a roller pivoted thereto, and in the top with a serrated cutter. The present invention is characterized by the cutter which is provided on the top side with an elastic protective piece having a front edge with a width equal to the length of the serrated blade of the cutter. The front edge of the protective piece extends beyond the cutter and is slightly curved downward. The protective piece shields the front edge of the cutter at the time when the tape dispenser is in the standby state. When the tape dispenser is put into service, the protective piece is curved outward, without interfering the cutting of the dispensed tape.

### FIELD OF THE INVENTION

The present invention relates generally to a packaging tool, and more particularly to a tape dispenser which is provided with means to prevent the hand of a user thereof from being accidentally cut by the tape dispenser.

### BACKGROUND OF THE INVENTION

The tape dispenser is an indispensable tool in the packaging department of various organizations. The conventional tape dispensers are apt to inflict bodily injuries to a user thereof. In addition, the garments of the packaging workers can be accidentally caught by the tape dispensers. Some of the conventional tape dispensers are provided over a cutter thereof with a turnable shield of a plastic material for shielding the cutter of the tape dispensers. The shield can be turned upwards to facilitate the cutting of the tape by the cutter of the tape dispenser. Such a protective shield as described above is defective in design in that it must be so turned as to locate at an appropriate position, thereby resulting in a great deal of inconvenience to a user of the tape dispenser. In addition, the protective shield is prone to deflection after being so turned to locate at the appropriate position. The deflection of the protective shield can adversely interfere with the operation of the tape dispenser. Moreover, the production of the protective shield calls for an additional capital expenditure for purchasing a molding tool which is used in the production of the protective shield.

### SUMMARY OF THE INVENTION

It is the primary objective of the present invention to provide a tape dispenser capable of preventing the bodily injuries of a user thereof and capable of preventing the tape dispenser from catching clothes.

It is another objective of the present invention to provide a tape dispenser with means to prevent the cutter of the tape dispenser from being impacted on by a foreign object, so as to prolong the service life span of the tape dispenser.

It is still another objective of the present invention to provide a tape dispenser with means to enable a user thereof to do the packaging in an automatic fashion.

It is still another objective of the present invention to provide a tape dispenser which is cost-effective.

The tape dispenser of the present invention comprises a hand grip which is provided at the top end with a base board fastened therewith. The base board is provided in the rear end of one side thereof with a tape pivoting portion for disposing a tape reel, and in the front end thereof with a seat body which is provided at the bottom with a roller pivoted thereto, and at the top with a cutter and a protective piece made of an elastic material. The protective piece has a front edge of a width equal to the length of the cutter. The front edge of the protective piece extends beyond the cutter such that the front edge is slightly curved downward. The front end portion of the protective piece is not fixed such that it can be caused by an external force to bend toward one side of the top of the cutter, and that it can return to its original form upon being relieved of the external force. When the dispenser is not in use, the front edge of the cutter of the tape dispenser is shielded by the protective piece. When the tape dispenser is being used, the protective piece bends outwards without interfering the dispensing operation.

### BRIEF DESCRIPTION OF THE DRAWINGS

FIG. 1 shows a partial exploded view of a preferred embodiment of the present invention.

FIG. 2 shows a longitudinal sectional view of the preferred embodiment of the present invention in the standby state.

FIG. 3 is similar to FIG. 2 to show that the cutter of the preferred embodiment of the present invention is prevented by the protective piece from being impacted on by a foreign object.

FIG. 4 shows a schematic view of the protective piece of the preferred embodiment of the present invention at work.

### DETAILED DESCRIPTION OF THE INVENTION

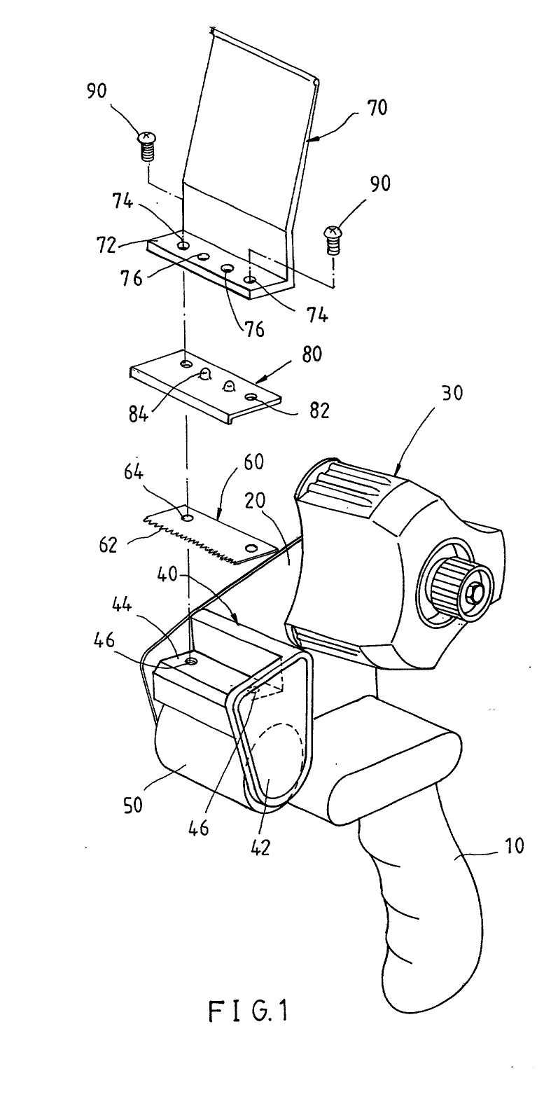

As shown in FIG. 1, a tape dispenser of the preferred embodiment of the present invention comprises a hand grip 10. A base board 20 is mounted on one side of the top end of the hand grip 10 and is provided on the rear end with a tape pivoting portion 30 for mounting pivotally a tape reel on a shaft. A seat body 40 is fixed on the front end of the side of the base board 20. A roller 50 is disposed at the bottom of the seat body 40 such that the roller 50 is horizontally pivoted between the base board 20 and the outer end face 42 of the seat body 40. A cutter 60 is mounted securely on the top 44 of the seat body 40 such that the serrated blade 62 of the front side of the cutter 60 is slightly extended beyond the front edge of the seat body 40 so as to facilitate the cutting of the tape. A oppression plate 70 of an L-shaped construction is fastened at a shorter underside 72 thereof with the top side of the seat body 40 such that the oppression plate 70 is located over the cutter 60.

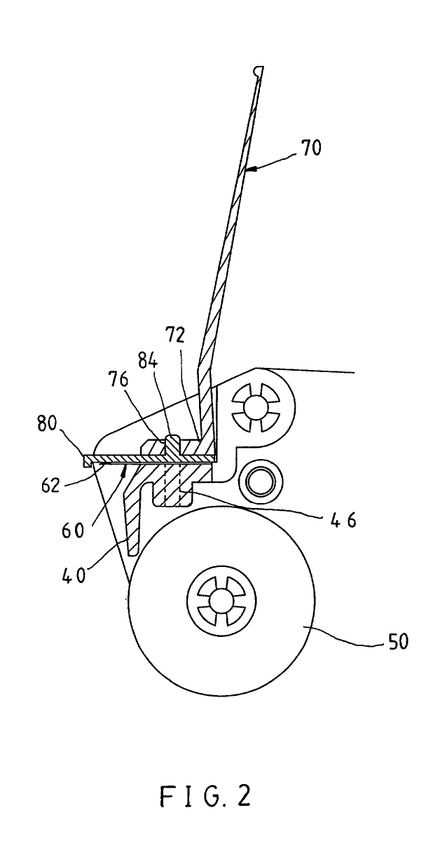

The structures described above are not subject matters of the present invention. The tape dispenser of the present invention is characterized by the cutter 60 which is further provided in the top with an elastic protective piece 80. The protective piece 80 of the preferred embodiment of the present invention is integrally made of a soft rubber by injection molding such that the protective piece 80 has a rectangular profile, a length, and a width. The protective piece 80 is corresponding in length and width to the cutter 60. As shown in FIG. 2, the protective piece 80 is sandwiched between the cutter 60 and the underside 72 of the oppression plate 70. The underside 72 of the oppression plate 70, the protective piece 80, and the cutter 60 are provided with two through holes 74, 82, 64 penetrating the top and the bottom thereof. These through holes 74, 82, 64 are aligned such that they are aligned with two threaded holes 46 of the top 44 of the seat body 40. Two screws 90 are put through the through holes 74 of the oppression plate 70, the through holes 82 of the protective piece 80, and the through holes 64 of the cutter 60 such that the screws 90 are engaged with the threaded holes 46 of the seat body 40. The seat body 40 is made of a plastic material. The threaded holes 46 are formed by the tapping of the metal screws 90. The oppression plate 70, the protective piece 80, and the cutter 60 are fastened with the top of the seat body 40. The protective piece 80 is provided in the top with two locating pillars 84 extending upwards. The oppression plate 70 is provided in the underside 72 with two fitting holes 76 into which the two locating pillars 84 of the protective piece 80 are inserted for accelerating the assembly of the component parts and for reinforcing the fixation structure of the protective piece 80. As shown in FIG. 2, after the assembly is done, the protective piece 80 is located on top of the cutter 60 such that the front edge thereof is slightly extended beyond the serrated blade 62 of the front side of the cutter 60, and that the front most end thereof is slightly curved downwards to extend beyond the underside of the cutter 60, thereby enabling the front side of the blade 62 to be shielded. The protective piece 80 is provided with a front end which is curved at right angle. The front end may be beveled or curved arcuately.

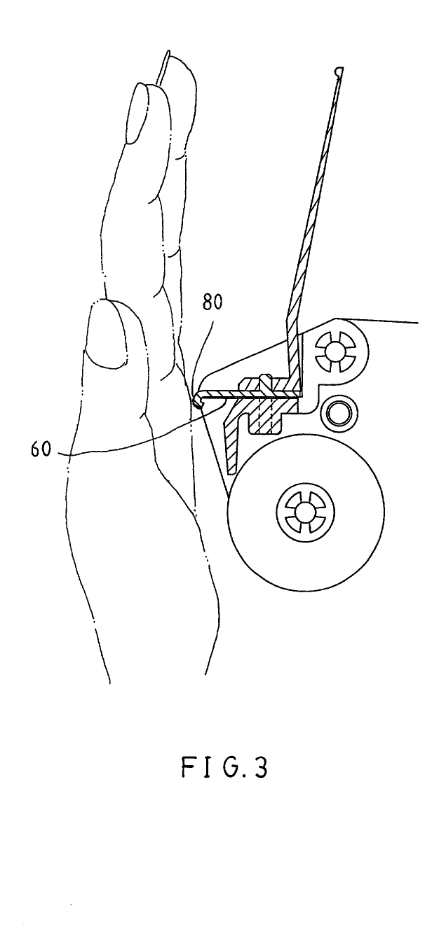

As shown in FIG. 2, when the tape dispenser of the present invention is in the standby state, the protective piece 80 is located in a planar position such that the front end thereof is slightly curved downward to shield the serrated blade 62 of the cutter 60. As shown in FIG. 3, when a foreign object, such as a human hand, approaches inadvertently the cutter 60 of the tape dispenser, the foreign object is shielded by the protective piece 80 which prevents the foreign object from making contact with the serrated blade 62 of the cutter 60. As a result, the hand of a user of the tape dispenser is protected against bodily injury caused by the serrated blade 62. On the other hand, the serrated blade 62 of the cutter 60 is protected against the impact of a foreign object, so as to prolong the service life span of the cutter 60.

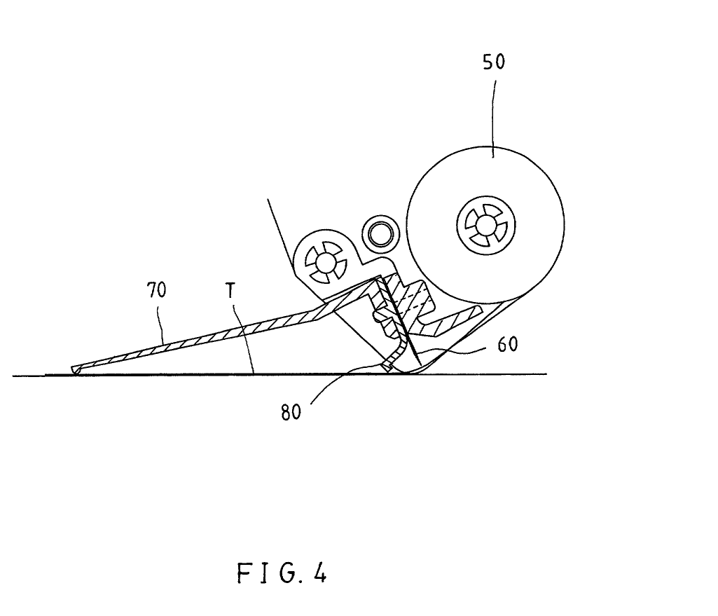

The tape dispenser of the present invention is similar in operating manner to the conventional tape dispensers such that the tape dispenser is moved backwards to allow the adhesive tape to extend along a packaging material, such as a cardboard box, and that the dispensed tape is pressed against by the tail end of the oppression plate 70, as illustrated in FIG. 4. At this stage, the underside of the front half segment of the pliable protective piece 80 is not joined with the cutter 60, with the top being free from the pressure of the underside 72 of the oppression plate 70, thereby curving toward one side of the top of the cutter without interfering the dispensing of the adhesive tape T. The dispensed tape is severed by turning inward the front end of the tape dispenser by means of the wrist action. This is done due to the fact that the protective piece 80 is already lifted to expose the serrated blade 62 of the cutter 60. As the tape dispenser is taken away from the packaging material, the protective piece 80 is not exerted on by the external force. As a result, the protective piece 80 returns to its original planar form to shield the front edge of the cutter 60.

The present invention is compatible with the conventional tape dispensers such that a rubber protective piece is incorporated into the conventional tape dispensers, without making a prior art rotary protective cover, and a prior art seat body with a pivoting hole to pivot the protective cover.

What is claimed is:

1. A tape dispenser comprising a hand grip which is provided at the top end with a base board fastened therewith, said base board being provided at a rear end of one side thereof with a tape pivoting portion for disposing a tape reel, and at the front end with a seat body which is provided at the bottom with a roller pivoted thereto, said seat body being further provided at a top with a cutter fastened therewith, said cutter having in a front edge a serrated blade;
wherein said dispenser further comprising an elastic protective piece which is fastened with the top side of said cutter and is provided with a front edge portion corresponding to the serrated blade of said cutter, said front edge portion having a width equal to a length of said serrated blade and extending beyond said cutter such that a front end of said front edge portion is slightly curved downward, said protective piece having a front end portion which is not fixed and is capable of curving toward a top of said cutter at such time when said protective piece is exerted on by an external force, said protective piece capable of returning to an original form thereof at such time when said protective piece is relieved of the external force exerting thereon.

2. The tape dispenser as defined in claim 1, wherein said protective piece has a rectangular profile corresponding in length and width to said cutter, said protective piece being stacked on the top of said cutter; wherein said tape dispenser further comprises an L-shaped oppression plate having a shorter underside which is stacked on the rear end of the top of said protective piece; wherein said underside of said oppression plate, said protective piece and said cutter are provided with two through holes which are aligned, and are fastened on the top of said seat body by two screws which are fastened onto said seat body via said through holes.

3. The tape dispenser as defined in claim 2, wherein said oppression plate is provided in the underside with two fitting holes; wherein said protective piece is provided in the top with two locating pillars which are inserted into said two fitting holes.

4. The tape dispenser as defined in claim 1, wherein said protective piece has a front end which is curved vertically and downward.
